(19) United States
(12) Patent Application Publication
(10) Pub. No.: US 2017/0280612 A1
(43) Pub. Date: Oct. 5, 2017

(54) Pick Shovel

(71) Applicant: John G. Teutsch, Santa Fe, NM (US)

(72) Inventor: John G. Teutsch, Santa Fe, NM (US)

(21) Appl. No.: 15/086,441

(22) Filed: Mar. 31, 2016

(51) Int. Cl. A01B 1/02; A01B 1/22; A01B 1/06; B25D 7/00

(52) U.S. Cl. CPC A01B 1/022; B25D 7/00; A01B 1/22; A01B 1/06

(57) ABSTRACT

An apparatus for shifting and transferring materials is provided, wherein the apparatus has an elongated handle and a blade affixed to an end of the elongated handle. The blade has a bottom and at least two side edges. The elongated handle extends upwardly from the blade at an acute angle relative to the bottom of the blade. The acute angle is approximately 65° such that an angle of the elongated handle relative to vertical is approximately 25°. A cap can be adapted to secure the elongated handle to the blade.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The invention relates generally to hand tools for gardening and excavating, and in particular to a pick shovel.

### 2. Description of Related Art Including Information Disclosed Under 37 CFR 1.97 and 37 CFR 1.98.

Conventionally, shovels have been used for years. Various designs are known to exist, such as the pointed digging shovels and square ended shovels used for coal and picking up debris pushed with a broom onto the shovel.

Shovels are generally used for digging or clearing an area for other similar. The handle joins the scoop or blade by being inserted into a handle tube affixed to the top edge of the blade or scoop. The handle tube is secured to the upper edge of the scoop generally midway between the two side edges of the scoop. The upper edge of the scoop serves as the point of placement of the foot of the person using the shovel to force the scoop of the shovel into the ground. The upper edges are normally not wide and often cause discomfort to the foot when the foot is pressed against the upper edge.

The current models while functional are not necessarily that easy to use. For example, the typical shovel has a long handle and a foot pad located on the base of the shovel. You can use the foot pad to help push the shovel into the ground. One problem with the typical shovel is that if you are short and are trying to use it, it is cumbersome with its long handle. Alternatively, if you are tall, the handle can be way too short. Typically, a spade has a shorter handle than a shovel yet it still contains a foot pad for helping to push the blade end. The shorter handle provides for better leverage, but places tremendous pressure on the back of the user.

Both prospectors and commercial gold mining companies have frequently found it difficult to penetrate the soil with existing hand tools. The presence of small stones and roots in the soil presents obstacles which may be very difficult to overcome. Most people have more than adequate strength in their backs and shoulders to remove all but the largest roots and stones, but due to the limitations of theiro tools, they attempt to get the job done with the smaller and much less powerful muscles of their arms and wrists. This makes the task very difficult, time-consuming and tiresome, resulting in sore muscles and frustration. A pick shovel, providing a sturdy, sharp shovel blade at a 25° angle to a conventional shovel handle, would resolve this problem.

A number of different types of applications and devices are available in the prior art for example;

U.S. Pat. No. 4,904,011 A to Hawk Ernest D shows a shovel formed of a blade member, two side members, a handle retaining member, and a handle. In one embodiment, each of the blade member, two side members and handle retaining member is formed as a metal blank, which is stamped, punched and bent to the desired configuration, with the metal blanks of the sides and handle retaining member having formed therein interlocking coacting detenting elements for enabling adjustment of the angle of the handle relative to the blade portion. Welds and a rivet complete the assembly of the shovel.

U.S. Pat. No. 5,887,921 A to Kombi Garden Tool, Inc. demonstrates a shovel having a rotatable foot pedal at the top edge of the scoop on each side of the point where the handle joins the scoop. When rotated forward, when the pedal is pressed down, the point of the scoop is directed straight down. When the pedal is rotated back, when the pedal is pressed down, the point of the scoop is forced forward. In addition, detachable handles of various types may be interchanged and the scoop of the shovel may have different edge configurations, including various sized teeth in the edge of the scoop to assist in cutting roots and other material that the shovel might encounter.

U.S. Pat. No. 7,104,576 B1 to Alan Dorr depicts a shovel, particularly useful for weeding soil, has a tubular socket with a proximal end having an opening configured to receive a distal end of an elongate handle. The socket has a slot configured to receive a proximal end of a blade at its distal end, the slot. The slot is further configured to receive the blade such that the proximal end of the blade is positioned continuously through the slot without interruption. The shovel further includes a foot step having platform for accommodating a person's foot at the proximal end of the blade. The footstep has a support integral with the platform such that the support contacts the bottom surface of the blade at a location distal from the proximal end to provide support to the blade and the platform.

U.S. Pat. No. 5,520,429 A to Gregory; Charles A. shows a shovel for digging narrow trenches, comprising a handle and a head, the head having at an upper end thereof a shank by which the head is secured to the handle and at a lower end thereof a blade which is slender and elongated and of generally U-shaped cross-sectional configuration. The blade is comprised by a bottom wall and side walls upstanding from the bottom wall. The side walls flare outwardly in the direction of the shank to form wings on opposite sides of the blade. The wings have bent-over portions serving as footrests for pressing the blade into the ground to dig a trench. The wings are so disposed as to bear on shoulders of a trench to serve as fulcra such that when the handle is depressed, the shovel will swing vertically about these fulcra and the blade will be raised. The blade is forwardly concave in a digging direction in a plane perpendicular to its cross section.

U.S. Pat. No. 5,669,649 A to Metcalf; Tom shows a ditch shovel is disclosed with a total weight between 9 and 15 pounds. The weight of the shovel allows the user to develop significant downward momentum to penetrate more deeply into the ground and dislodge more compacted earth. However, none of the above inventions and patents, taken either singly or in combination, is seen to disclose a sturdy, sharp shovel blade at a 25° angle to a conventional shovel handle, enabling the user to swing the tool from the shoulders like a pick, rather than thrusting down like a shovel.

### BRIEF SUMMARY OF THE INVENTION

The primary objective of the present invention is to provide a sturdy, sharp shovel blade at a 25° angle to a conventional shovel handle, enabling the user to swing the tool from the shoulders like a pick, rather than thrusting down like a shovel. The blade easily cuts through small roots in the soil and drives stones to the side, enabling the user to dig a small hole with maximum efficiency.

In one objective of the present invention provides a pick shovel used for shifting and transferring materials comprising an elongated handle, a spade and a means for affixing said elongated handle to said spade, secured to said spade at the top edge. Further the elongated handle of the pick shovel used for shifting and transferring materials comprise of a first end and a second end.

Moreover the spade of the pick shovel used for shifting and transferring materials comprise a planar frame with at least a first edge, at least two side edges and a front surface and a back surface.

In another objective the present invention to provide a pick shovel for moving, sand, gravel, and soil. The shovel blade is at a 25-degree angle to a handle with a pulling mechanism. The 25-degree angle of the blade allows a user to penetrate soil with little effort. The pulling mechanism; allows a user to move the soil with a pulling option instead of pushing the shovel into the soil.

The summary is provided to introduce a selection of concepts in a simplified form that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 shows a perspective view of the present invention.

### DETAILED DESCRIPTION OF THE INVENTION

The following is a detailed description of example embodiments of the invention that is depicted in the accompanying drawings. The example embodiments are in such detail as to clearly communicate the invention. However, the amount of detail offered is not intended to limit the anticipated variations of embodiments. On the contrary, the intention is to cover all modifications, equivalents, and alternatives falling within the spirit and scope of the present invention. The detailed descriptions below are designed to make such embodiments obvious to a person of ordinary skill in the art.

Referring now to the invention in more detail, the invention is directed to a pick shovel.

It is to be understood that while the invention is intended to be used for the purpose of gold prospecting. This is not intended as a limitation. With suitable modifications or with no modifications at all, the invention may be used for other purposes, such as gardening, where it is desirable to rapidly and efficiently dig a hole to a fairly shallow depth with a minimum of effort.

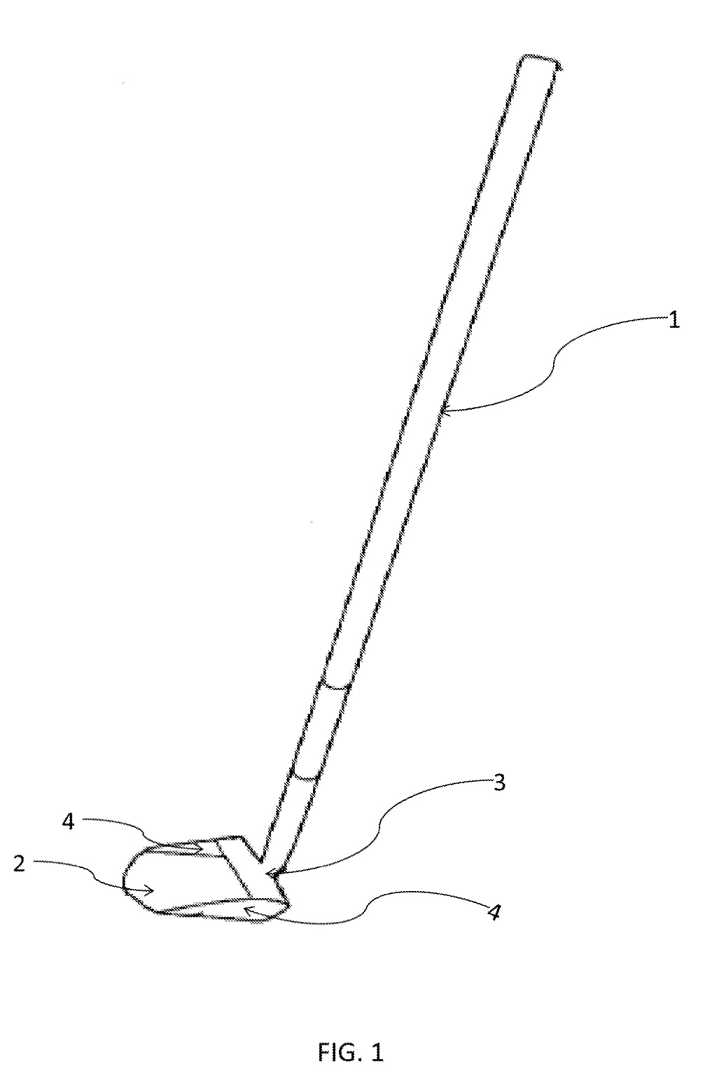

Referring to the drawings specifically to FIG. 1 of the drawings thereof, is shown a perspective view of a pick shovel for clearing a surface with an elongated shovel handle 1 to provide an ease of use to a user, a spade 2 and a cap 3 to secure the elongated shovel handle 1 to the spade 2. Further the elongated handle 1 has two ends a first end and a second end which caps in the spade 2 using a cap 3. Moreover the spade 2 has a planar frame with at least an edge and at least two side edges 4 on its front surface and a back surface. The planner frame of the spade is a leading edge a lagging edge.

In one embodiment of the invention, the cap 3 used as a means for affixing the elongated handle 1, which may be of variable length, to the spade 2 is generally midway between the two side edges 4 of the spade 2. Further, according to the same embodiment sides of spade converges towards the center forming a pointed structure.

Further, in another embodiment the spade of the pickup shovel may be selected from a group consisting of a shovel blade, rake blade, hoe blade, trowel blade, roller blade, scooper blade, pick blade and scoop and the spade of the pick shovel may be made of a material selected from a group consisting of wood, plastic, steel and aluminum. Furthermore, the elongated handle of the pick shovel may be made of a material selected from a group consisting of wood, plastic, steel and aluminum. Also the elongated handle is replaceable.

Moreover, according to the invention, the elongated handle and the spade forms a V-shaped groove and the spade may be designed to retain item selected from a group consisting of drain water, mud, stones, gravel and sand.

The first exemplary embodiment is comprised of a hand tool which is similar in structure and function to a conventional, long-handled digging shovel, with the following modifications. A sturdy, sharp shovel blade 11 is provided at a 25° angle to the handle, enabling the user to swing the tool from the shoulders like a pick, rather than thrusting down like a shovel.

The blade provides significantly greater depth than a conventional shovel blade and squared off sides, similar to a trenching shovel, enabling the user to move much greater amounts of soil and other material without disturbing the surrounding material. The blade easily cuts through small roots in the soil and drives stones to the side, enabling the user to dig a small hole with maximum efficiency.

The pick shovel may be used to dig in and remove soil, gravel, or sand. The rear surface of the blade provides a broad, flat blade butt. If the blade is encountering difficulty moving through the material, the user may step on the blade butt, urging the blade downward.

The length of the pick shovel is preferably 44 inches, with a blade which is preferably 11 inches long, 6 inches wide at the blade butt, and 4 inches wide at the tip. The blade is preferably angled 2.5 inches past vertical on the handle, prodding a 25° angle to the handle.

To use the first exemplary embodiment, the user selects a spot to dig, grasps the handle with both hands, and swings the pick shovel downward such that the blade is driven into the ground. If the blade is not driven into the desired depth, the user may elect to step on the blade butt to drive the blade further into the ground. The user may then work the handle back and forth to loosen the soil, and lift or pry upward with the handle to lift a blade full of soil out of the newly created hole. The user may repeat this process until a hole of sufficient depth is created or sufficient material has been removed.

The blade is preferably manufactured from a rigid, durable material of substantial strength, such as steel or aluminum alloy. The handle is preferably manufactured from a rigid, durable material which is lightweight, such as wood.

Components, component sizes, and materials listed above are preferable, but artisans will recognize that alternate components and materials could be selected without altering the scope of the invention.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. An apparatus for shifting and transferring materials, the apparatus comprising:
an elongated handle; and
a blade affixed to an end of said elongated handle, said blade having a bottom and at least two side edges, said elongated handle extending upwardly from said blade at an acute angle relative to said bottom of said blade.

19. The apparatus of claim 18, said acute angle being approximately 65 degrees.

20. The apparatus of claim 19, an angle of said elongated handle relative to vertical being approximately 25 degrees.

21. The apparatus of claim 18, further comprising:
a cap adapted to secure said elongated handle to said blade.

22. The apparatus of claim 18, said blade having a pointed end.

23. The apparatus of claim 18, wherein said blade may be selected from a group consisting of a spade, shovel blade, rake blade, hoe blade, trowel blade, roller blade, scooper blade, pick blade and scoop.

24. The apparatus of claim 18, said blade may be made of a material selected from a group consisting of wood, plastic, steel and aluminum.

25. The apparatus of claim 18, wherein said elongated handle may be made of a material selected from a group consisting of wood, plastic, steel and aluminum.
